(19) United States
(12) Patent Application Publication
(10) Pub. No.: US 2010/0260897 A1
(43) Pub. Date: Oct. 14, 2010

(54) Commercial bakery sandwich breads and rolls products

(76) Inventor: Neil Charles Schoen, Montgomery Village, MD (US)

Correspondence Address: Neil C. Schoen, 9817 Freestate Place, Montgomery Village, MD, 20886-3158, US

(21) Appl. No.: 12/386,044

(22) Filed: Apr. 14, 2009

(51) Int. Cl. A21D 13/00; A23P 1/00

(52) U.S. Cl. 426/94; 99/426

(57) ABSTRACT

An improvement to a variety of sandwich-based bakery products to prevent “leakage” of food from the sandwich while eating, due to the open sides of present sandwich bakery products. Leakage is avoided by using separate baking-pan molds to create top and bottom parts of a variety of sandwich-like products (e.g., hamburger rolls, English muffins, submarine rolls, and soft taco/burrito shells). The top and bottom parts of most of the products contain outside walls that have a crust layer created by the baking molds that prevents food from falling or squirting out of the sandwich product due to gravity or pressure from biting or squeezing the sandwich product during eating. The one-piece burrito product has “wings” which, when folded properly, prevents leakage of the contents during eating and reduces the multiple end layers created when “rolling up” a conventional burrito.

### BACKGROUND OF THE INVENTION

Sandwiches made with current mass-produced sandwich products allow food to fall out under pressure from holding or biting into the sandwich. This is especially true for certain sandwich fillings, such as egg salad and tuna salad. The present invention prevents this from happening due to interlocking walls on the top and bottom segments of the sandwich, created by the two nested baking pans. The side-walls of the baking pans create overlapped crusted layers, which provides a tight barrier to prevent the contents of the sandwich to fall or squirt out while holding or eating. A modification of this principle allows creation of “leak-proof” soft taco and burrito sandwiches by creating rectangular appendages which fold over the filings to create a thinner, leak-proof sandwich product.

### SUMMARY OF THE INVENTION

The primary objective of this invention is to prevent leakage of self-made sandwich-like products by creating interlocking walls to the sandwich top and bottom components. This can be accomplished by use of baking pans that create crusted side walls to the top and bottom sandwich components, allowing for a secure barrier to prevent food from escaping from the sandwich due to gravity or pressure from holding or eating. This process is also applicable to square-shaped sandwich breads (the cross-section is identical to that in FIG. 2).

An analogous approach, which creates a monolithic thin layer, with appropriate “wings” and corner “barriers”, allows the roll-up of a burrito sandwich which will eliminate multiple overlapping end pieces present in conventional round burrito shells. Use of two baking molds shown in the Figures, but with much less space for dough, allows creation of a soft taco shell. This taco shell prevents leakage in a manor similar to that described above for rolls or sandwiches.

### BRIEF DESCRIPTION OF THE DRAWINGS

FIG. 1 is a cross-sectional view of a muffin and a bun or roll with food showing (hamburger and tomato for example). Round (e.g., roll) and square (e.g., sliced bread) bakery products will conform to the FIG. 1 drawings.

FIG. 2 is a diagram that shows the shape of the baking forms (pans) needed to create the overlapping side surfaces which contain the roll or sandwich contents. For square sandwich products, the outer and inner overlapping baking forms are identical in separation for both the top and bottom cross-sectional views.

FIG. 3 is a top cross-sectional view of the baking forms for a submarine sandwich (“sub”) or “hoagie”. The forms can also be rectangular, as opposed to the rounded ends of most sub rolls.

FIG. 4 shows a cross-sectional view of a soft taco product This product is formed as a flat circular thin dough layer, with upright edges and two gaps diametrically opposed, to allow fold-over of the soft taco shell. The food is placed on one side, and the other side folds over with a slight stretching to overlap the upright edges and seal the contents.

FIG. 5 shows a top view of a soft burrito shell. This product is formed as a flat thin dough layer, with wings at the left and right side. The food is distributed in the center region, and the left/right small wings (#1, #2) are folded over first. Then the top/bottom large wings (#3, #4) are folded over in the order shown. This provides a leak-proof seal to contain the contents.

### DETAILED DESCRIPTION OF PREFERRED EMBODIMENTS

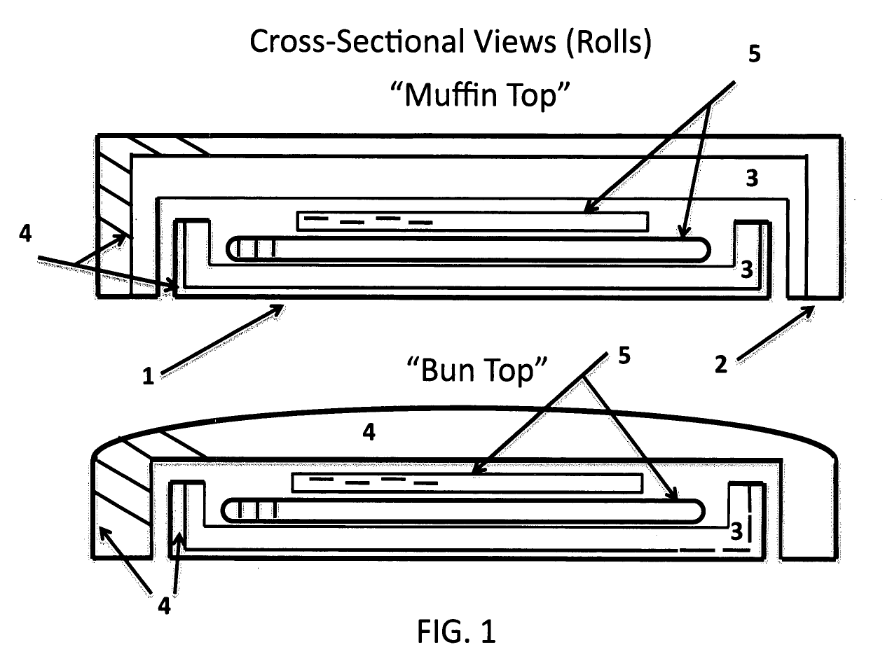

As illustrated in FIG. 1, the round rolls consist of an inner bottom piece 1 and outer piece 2. The outer surfaces of both pieces of the roll have a thick edge crust outer layer 4 to provide strength to contain the food contents 5 of the sandwich during handling or eating. The top layer can have a thinner crust outer layer as in a normal English muffin or hamburger bun.

The bottom inside layer has a uniform thin crust as is normal for muffins, rolls or breads. The interior layers of both top and bottom pieces 3 have little or no crust, which can be produced by cooling the inner baking pans of both top and bottom pieces.

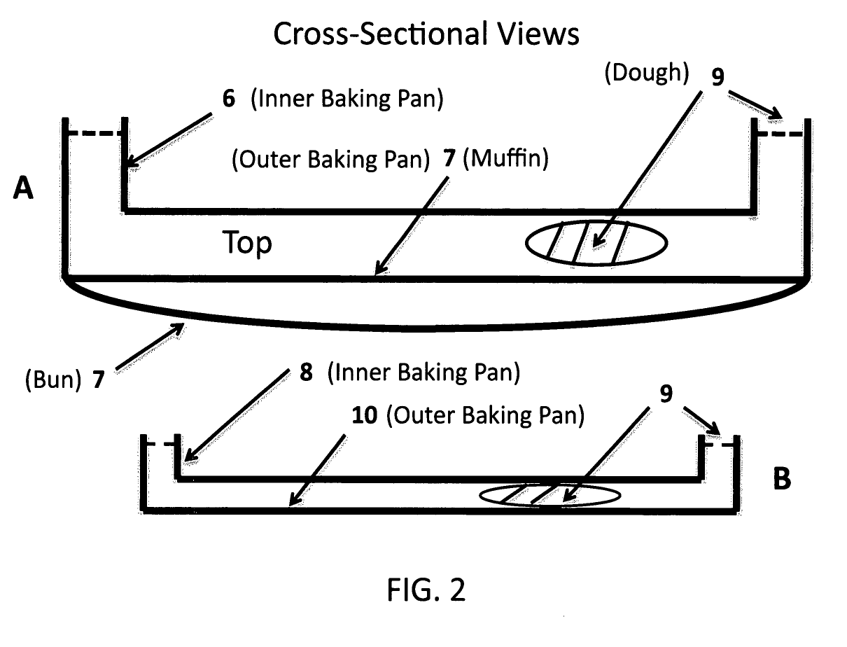

The baking pans, as shown in FIG. 2, consist of an inner and outer baking pan 8 and 10, denoted by the B label, for producing the bottom portion of the rolls or muffins. The top portion, denoted by the A label, has a similar, but larger diameter and thickness for the inner 6, and outer 7, baking pan components. Both A and B are filled to near the top with typical bread dough 9, that has been allowed to expand before baking.

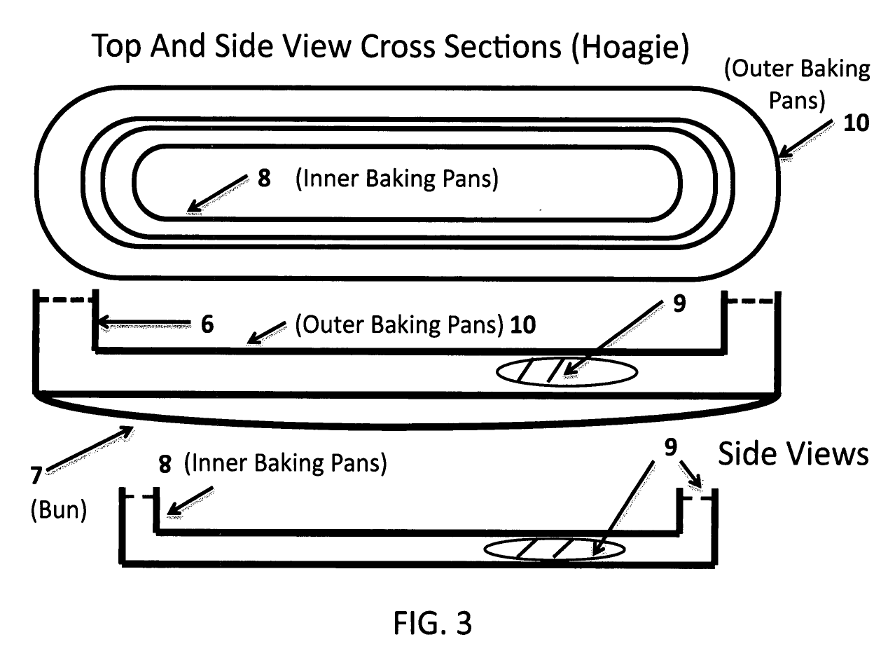

FIG. 3 shows a similar configuration for a submarine or “hogie” sandwich. The inner and outer baking pans 8 and 10 are identical to the prior baking forms shown in FIG. 2 B except for the elongated shape and curve ends.

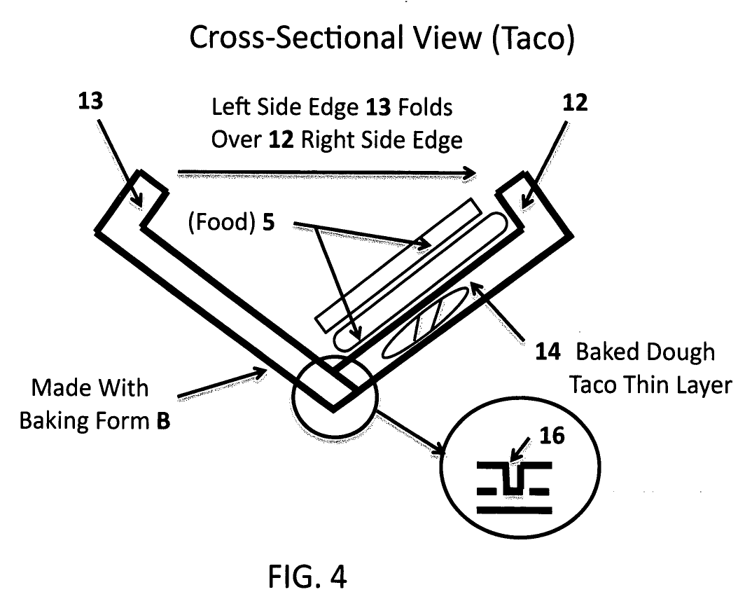

The baking pan configuration for a soft taco is shown in FIG. 4. Baking Form B for this product is designed to be thinner and not produce a crust. The baking dough ingredient 14 produces a thin layer after baking. The two halves of the taco 13 and 12 are folded over after the component foods (for example, ground beef lettuce and cheese) 15 are placed inside. The left side edge 13 is then folded over the right side edge 12 to provide a leak-proof seal during handling while eating. Two small gaps 16 in the edges at diametrically opposed positions on the taco side-walls allows the left edge to slide over the right edge to seal in the contents.

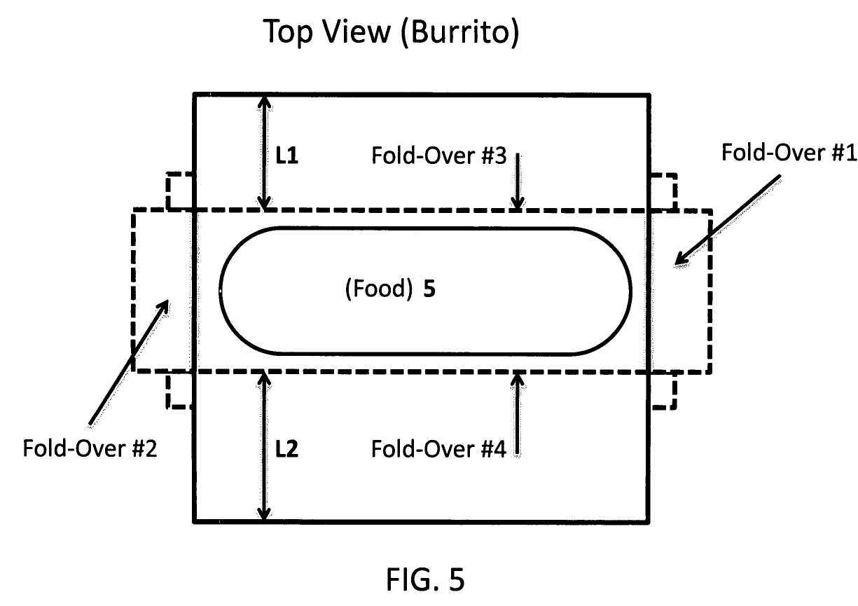

FIG. 5 contains a top view of a soft taco product, and is created using a special form for cutting out the necessary configuration shown in the figure. The two side fold-over segments (Fold-Over #1 and #2) are flipped over after the food 15 (for example, beans, lettuce, cheese, ground beef) is added. Then the remaining segments (Fold-Over #3 and #4) are wrapped around the food to provide a leak-proof seal while eating.

What is claimed is:

1. An improvement to a variety of sandwich-based bakery products to prevent “leakage” of food from a sandwich while eating, comprising:
means to produce top and/or bottom pieces of sandwich-based products in a variety of sizes, with side-wall crusts of varying thickness which prevent the contents of said sandwich from leaking out while eating, and wherein;
said top and bottom pieces of said sandwich-based products are produced using two sets of interlocking baking pans to produce outer surface crusts for the top and bottom pieces of said sandwich-based products, and wherein;
said bottom piece, for creation of soft taco products, is produced using the smaller bottom set of interlocking baking pans to produce the thin flat dough shells found in current supermarket commercial taco products, and wherein;
said flat bottom piece, for creation of burrito products, is identical in composition to current supermarket commercial burrito products, with the exception that said bottom piece is rectangular in shape, and has cut-outs to produce a leak-proof wrapping around the filling food contents.

2. A sandwich product according to claim 1 wherein said variety of sandwich-based products includes, but is not limited to; English muffins, hamburger rolls, hot dog rolls, submarine/hoagie rolls, soft taco shells, and burrito shells.

3. A sandwich product according to claim 1 wherein the empty inner top pans of said sandwich interlocking baking pans can contain water while baking to prevent a crust from forming on the inside of both top and bottom pieces of said bakery products.

4. Sandwich products according to claim 1 wherein the dough ingredients and baking times used to create said sandwich products can be obtained using the recipes found in many published cookbooks.
